(19) United States
(12) Patent Application Publication
(10) Pub. No.: US 2025/0285150 A1
(43) Pub. Date: Sep. 11, 2025

(54) INFORMATION PROCESSING APPARATUS, METHOD AND NON-TRANSITORY COMPUTER READABLE MEDIUM

(71) Applicant: KABUSHIKI KAISHA TOSHIBA, Tokyo (JP)

(72) Inventors: Kiichi Goto, Kawasaki Kanagawa (JP); Yasutoyo Takeyama, Kawasaki Kanagawa (JP); Ryusuke Hirai, Tokyo (JP)

(73) Assignee: KABUSHIKI KAISHA TOSHIBA, Tokyo (JP)

(21) Appl. No.: 19/044,243

(22) Filed: Feb. 3, 2025

(30) Foreign Application Priority Data
Mar. 6, 2024 (JP) 2024-034158

(51) Int. Cl. G06Q 30/0283; G06Q 30/0282

(52) U.S. Cl. CPC G06Q 30/0283; G06Q 30/0282

(57) ABSTRACT

According to one embodiment, an information processing apparatus includes a processor. The processor acquires graph data in which nodes of subjects and edges of a relationship between the subjects. The processor generates additional graph data in which one or more personas are added to the graph data as the nodes. The processor extracts subject representations and persona representations from the additional graph data, using a model for extracting representations. The processor calculates first loss depending on difference between similarity between nodes connected by the edge and similarity between nodes not connected by the edge. The processor calculates second loss depending on difference between similarity between node of the subject and node connected to the node of the subject, and similarity between node of the persona and node connected to the node of the persona. The processor updates the model, using the first and second losses.

### CROSS-REFERENCE TO RELATED APPLICATION

This application is based upon and claims the benefit of priority from Japanese Patent Application No. 2024-034158, filed Mar. 6, 2024, the entire contents of which are incorporated herein by reference.

### FIELD

Embodiments described herein relate generally to information processing apparatus, method, and non-transitory computer readable medium.

### BACKGROUND

Data of product purchases and reviews by users can be handled as bipartite graphs in which the users and the items are represented by nodes, and the purchasing relationship and the review relationship are represented by edges. In recent years, attention is being drawn to a recommendation system technology for recommending an item to a user by a graph analysis technique such as a graph neural network (GNN) for such bipartite graphs.

In the recommendation system technology using a graph analysis technique, a high-order relationship between users and items is adopted, features of each user and each item are extracted, and a model is trained so that a purchase probability between a user and an item in a purchasing relationship becomes higher than a purchase probability between a user and an item not in a purchasing relationship.

A certain user is divided in accordance with preferences or the like, and the divided aspects are referred to as personas. By training the recommendation system with the personas, it is possible to expect recommendations more suitable for individual preferences. However, in the recommendation system technology, relative levels (ranks) of a purchase probability between a certain user or persona and a purchased item, and a purchase probability between a certain user or persona and an unpurchased item is learned. Therefore, there is a problem in that a relative relationship indicating which of the user and a persona is likely to purchase an item cannot be learned, and interpretability is poor.

### BRIEF DESCRIPTION OF DRAWINGS

FIG. 1 is a block diagram showing an information processing apparatus according to the present embodiment.

FIG. 2 is a flowchart showing an example operation to be performed by the information processing apparatus according to the present embodiment.

FIG. 3 is a diagram showing an example of additional graph data according to the present embodiment.

FIG. 4 is a diagram showing an example of additional graph data in a case where communities are formed.

FIG. 5 is a diagram showing a relationship between nodes in a case where a recommendation loss is calculated based on additional graph data.

FIG. 6 is a diagram showing a relationship between nodes in a case where a recommendation loss is calculated based on additional graph data.

FIG. 7 is a diagram showing a relationship between nodes in a case where a comparison loss is calculated based on additional graph data.

FIG. 8 is a diagram showing an example of the hardware configuration of the information processing apparatus.

### DETAILED DESCRIPTION

In general, according to one embodiment, an information processing apparatus includes a processor. The processor acquires graph data in which a plurality of subjects is represented by nodes for each of two or more categories, and a relationship between the subjects is represented by an edge connecting the nodes. The processor generates additional graph data in which one or more personas having representative features of the subjects are added to the graph data as the nodes. The processor extracts subject representations and persona representations from the additional graph data, using a model for extracting representations. The processor calculates a first loss depending on a difference between a similarity between nodes connected by the edge and a similarity between nodes not connected by the edge, using the subject representations and the persona representations. The processor calculates a second loss depending on a difference between a similarity between a node of the subject and a node connected to the node of the subject, and a similarity between a node of the persona and a node connected to the node of the persona, using the subject representations and the persona representations. The processor updates the model, using the first loss and the second loss.

In the description below, an information processing apparatus, a method, and a non-transitory computer readable medium according to the present embodiment will be described in detail with reference to the drawings. Note that, in the following embodiment, portions denoted by the same reference numerals perform the same operations, and explanation of them will not be repeatedly made.

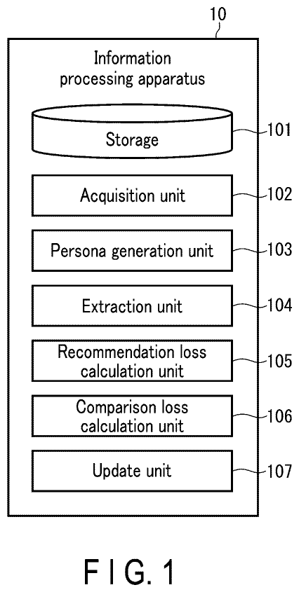

An information processing apparatus 10 according to the present embodiment will be described with reference to a block diagram in FIG. 1.

The information processing apparatus 10 according to the present embodiment includes a storage 101, an acquisition unit 102, a persona generation unit 103, an extraction unit 104, a recommendation loss calculation unit 105, a comparison loss calculation unit 106, and an update unit 107.

The storage 101 stores graph data, models, and the like. The graph data is data related to a graph in which each subject is represented by a node for each category that is a set of a plurality of subjects, and a relationship between the subjects is represented by an edge connecting the nodes. In the present embodiment, a subject represented by a node in a graph is referred to as a subject node. The graph data is a bipartite graph having two categories, for example, and is data including a relationship between the two categories, in which a subject node belonging to one category is connected to a subject node belonging to the other category by an edge. Specifically, in the case of graph data indicating a purchasing relationship between a person and a product (including a service), the person and the product are categories, an individual belonging to the category of “person” and an individual product belonging to the category of “product” are represented by nodes, and the purchasing relationship is represented by an edge. Further, in the case of graph data indicating a visiting relationship between a person and a place such as a tourist spot or a commercial facility, the person and the place are categories, an individual belonging to the category of “person” and a tourist place name or a commercial facility name belonging to the category of “place” are represented by nodes, and the visiting relationship is represented by an edge. In each node, a new subject (node) may be added in accordance with the attribute of the node, and a knowledge graph may be constructed. In the description below, for ease of explanation, a case where the two categories of “user” and “product” each include a plurality of subjects as two categories will be explained, but graph data indicating a relationship between two or more categories may be used.

The acquisition unit 102 acquires the graph data from the storage 101 or the outside.

The persona generation unit 103 generates additional graph data in which one or more personas indicating the features of the subject are added as a node. A persona is information indicating a characteristic aspect such as a preference of the subject to which the persona belongs.

The extraction unit 104 extracts subject representations and persona representations from the additional graph data, using a model for extracting representations.

The recommendation loss calculation unit 105 uses the subject representations and the persona representations, to calculate a recommendation loss (also referred to as a first loss) depending on a difference between similarity between nodes connected by an edge and similarity between nodes not connected by an edge.

The comparison loss calculation unit 106 uses the subject representations and the persona representations, to calculate a comparison loss (second loss) depending on a difference between the similarity between the subject node and a node connected to the subject node and the similarity between a persona node that is a node related to the persona and a node connected to the persona node.

The update unit 107 updates the model used in the extraction unit 104, using the recommendation loss and the comparison loss.

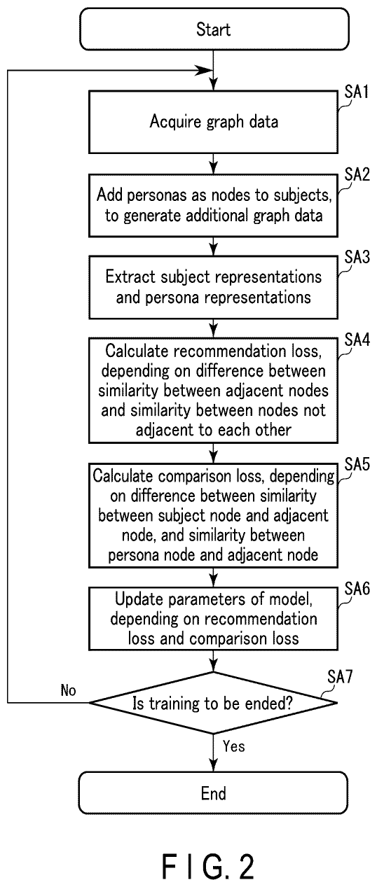

Next, an example of an operation to be performed by the information processing apparatus 10 according to the present embodiment is described with reference to a flowchart in FIG. 2.

In step SA1, the acquisition unit 102 acquires graph data. In the graph data, each node may have an edge between nodes of the same subject. Each node initial value may be attribute information such as a label, a category, and a parameter, or an order in graph theory, an embedding vector obtained by Deepwalk or node2vec, or random initialization may be used.

In step SA2, the persona generation unit 103 generates a persona for each node based on node information about the graph data and information about an edge between nodes, adds the generated persona as a node to the graph data, and thus, generates additional graph data. The persona may be generated by the persona generation unit 103 using a technique called “SPLITTER” according to Patent Literature 1, an egocentric network, a graph Laplacian, or a rich curvature, for example, and a general technique may be used.

Further, the persona generation unit 103 adds the edge duplicated from each node to the persona. The addition of the persona is assumed to be performed for all subject nodes included in at least one category of graph data, but may be performed only for at least one category, instead of all the categories.

In step SA3, the extraction unit 104 extracts subject representations and persona representations from the additional graph data obtained by the processing in step SA2. As for the extraction of the subject representations and the persona representations, the representations related to the subject and the representations related to the persona may be extracted from the additional graph data using a graph convolution network, for example. Note that it is not limited to this, and the subject representations and the persona representations may be extracted using a graph neural network having another message passing mechanism, such as a graph attention network (GAT), GraphSAGE, or a graph isomorphism network (GIN).

In step SA4, the recommendation loss calculation unit 105 uses the subject representations and the persona representations, to calculate a recommendation loss depending on a difference between the similarity between adjacent nodes and the similarity between non-adjacent nodes. Nodes include the subject node and a persona node. The recommendation loss L_{CF} in the enhancement filtering can be expressed by the following Expression (1), for example.

$${L}_{CF} = \sum - ln σ ( y ( u , i ) - y ( {u}_{p} , j ) ) \qquad ( 1 )$$

Here, u represents the representations of the subject node related to the first subject (user), i represents the representations of a node related to a second subject (product) to which a node and an edge related to the first subject (user) are connected, uₚ represents the representations related to the persona node of the first subject (user), j represents the representations of a node related to the second subject (product) to which the node and the edge related to the first subject (user) are not connected, and y (u, i) represents the similarity in representations between the node related to the first subject and the node of the second subject to which the edge is connected, which is the similarity in representations between the user and the product or the persona of the product in an adjacency relationship. Further, y (uₚ, j) represents the similarity in representations between the persona node related to the persona of the first subject and the node of the second subject to which any edge is not connected, which is the similarity in representations between the user and the product or the persona of the product that are not in an adjacency relationship.

Note that, as the adjacency relationship, a connection relationship by an edge between the node of the first subject and the node of the second subject, a connection relationship by an edge between the node of the persona of the first subject and the node of the second subject, a connection relationship by an edge between the node of the first subject and the node of the persona of the second subject, and a connection relationship by an edge between the node of the persona of the first subject and the node of the persona of the second subject can be taken into consideration.

An inner product of the subject representations and the persona representations may be used as the similarity, but any method by which a similarity between representations, such as a cosine similarity, can be calculated. Further, it is assumed that a difference between similarities is used as the recommendation loss L_{CF}, but any method that can be used for calculation of a loss may be used. Here, the recommendation loss calculation unit 105 calculates a loss for all of one subject (the user or the product) of the graph data and the persona of the subject, and outputs an average of the losses as the recommendation loss L_{CF}.

In step SA5, the comparison loss calculation unit 106 uses the subject representations and the persona representations, to calculate the comparison loss L_{PS} depending on the difference between the similarity between the representations related to the subject node and the representations related to the adjacent node, and the similarity between the representations related to the persona node and the representations related to the adjacent node. For example, it can be expressed by the following Expression (2).

$${L}_{P S} = \sum - ln σ ( y ( {u}_{p} , i ) - y ( u , i ) ) \qquad ( 2 )$$

Like the recommendation loss L_{CF}, the similarities may be calculated as inner products, cosine similarities, or the like. The difference in similarity may be a difference between the similarities. The comparison loss calculation unit 106 calculates a loss for all of the representations of one subject node (the user or the product) of the graph data and the persona of the subject, and outputs an average of the losses as the comparison loss L_{PS}.

In step SA6, the update unit 107 trains the model to be used in the extraction unit 104, depending on the recommendation loss L_{CF} and the comparison loss L_{PS}. Specifically, a total loss L_{TOT} is calculated from the recommendation loss L_{CF} and the comparison loss L_{PS}. The total loss L_{TOT} is expressed by Expression (3).

$${L}_{tot} = {L}_{CF} + {L}_{PS} \qquad ( 3 )$$

Based on the total loss L_{TOT}, the update unit 107 updates the parameters (weight and bias) of the model so that each difference in similarity between the recommendation loss L_{CF} and the comparison loss L_{PS} becomes larger. The initial value or the representations related to a node may be a trainable weight.

In step SA7, the update unit 107 determines whether the updating of the parameters of the model has been completed, which is whether the training of the model has been completed. In the determination as to completion of the parameter updating, it may be determined that the training is completed in a case where the value of a loss becomes equal to or smaller than a threshold, for example. Also, in a case where the parameters have been updated a predetermined number of times, it may be determined that the training has ended. Further, it may be determined that the training has ended in a case where the absolute value of the update amount of a parameter or the sum of the absolute values becomes a constant value. Note that the determination as to whether the training has been completed is not limited to the above example, and a termination condition normally employed in machine learning may be used. If the training has been completed, the process is terminated. If the training has not been completed, the process returns to step SA1 to continue the processing for the next graph data.

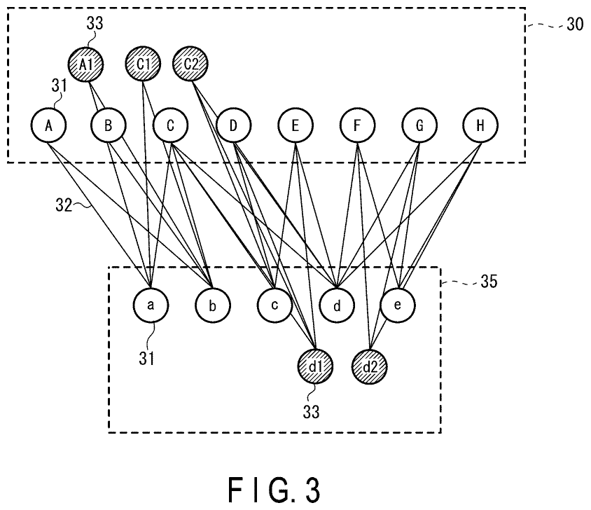

Next, an example of the additional graph data in a case where a persona according to the present embodiment is added is described with reference to FIG. 3.

FIG. 3 is a bipartite graph showing two different categories A30 and B35 and a relationship between the two categories. The category A30 is a set formed mainly with users, and user information is expressed by a plurality of subject nodes 31. Specifically, it is assumed that the eight subject nodes 31 from “user A” to “user H” belong to the category A30. For ease of explanation, a node related to the user A is also referred to as the subject node A, and subject nodes related to the other users are also referred to in a similar manner.

Meanwhile, the category B35 is a set formed mainly with products, and the products are expressed by a plurality of subject nodes 31. Specifically, it is assumed that the five subject nodes 31 from “product a” to “product e” belong to the category B35. For ease of explanation, a node related to the product a is also referred to as the node a, and nodes related to the other products are also referred to in a similar manner.

Further, in a case where a subject belonging to the category A30 and a subject belonging to the category B35 have a relationship, they are connected by an edge 32. Being connected by the edge 32 is also expressed as “nodes are adjacent”. Specifically, it can be seen that the edge 32 is connected to each of the subject node C of the “user C” belonging to the category A30, the subject node a of the “product a”, the subject node b of the “product b”, the subject node c of the “product c”, and the subject node d of the “product d”, and has a relationship with each of them. In other words, the subject node C is adjacent to the subject node a, the subject node b, the subject node c, and the subject node d.

In FIG. 3, a persona is generated for each of the user A, the user C, and the product d, and persona nodes 33 that are nodes corresponding to the personas are added. Specifically, a persona node A1 and persona nodes C1 and C2 are generated in the category A30, and persona nodes d1 and d2 are generated in the category B35. Edges 32 are then duplicated. For example, the persona node A1 is connected to the subject node a and the subject node b by the respective edges 32.

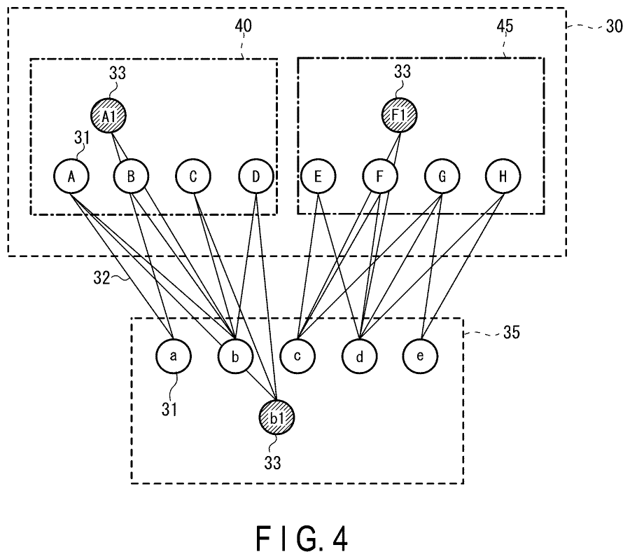

Note that a community may be generated for each subject. FIG. 4 illustrates an example of additional graph data in a case where communities are formed.

Personas are assigned to the respective communities of a plurality of communities to which the nodes belong. In the example in FIG. 4, the persona node A1 is added to a community 40 from a subject node belonging to the community 40, and a persona node F1 is added to a community 45 from a subject node belonging to the community 45. Note that a group of nodes of the same subject sharing a node of another subject may be used as a community.

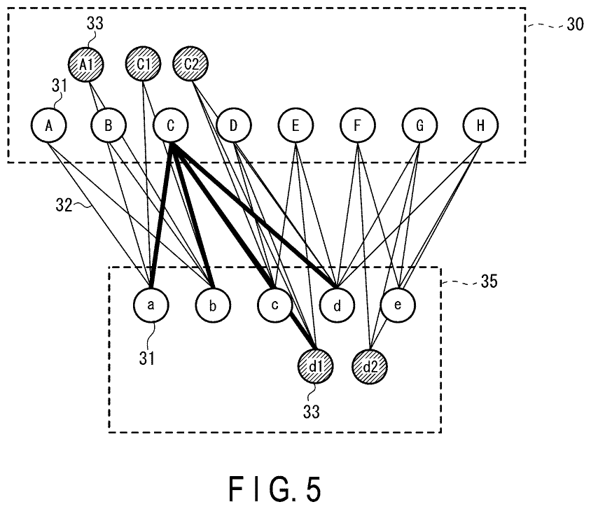

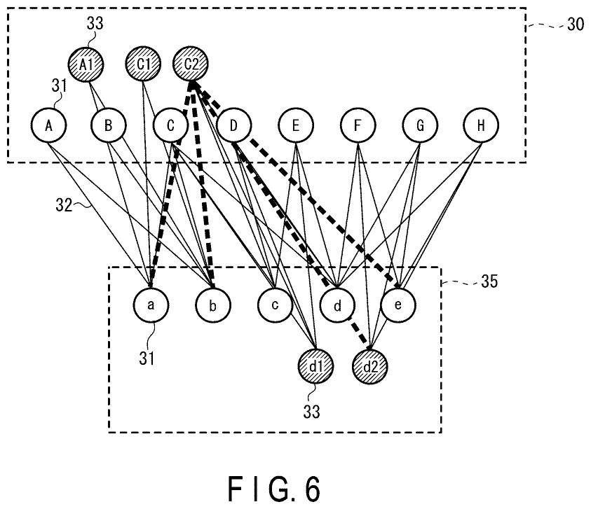

Next, a relationship between nodes in a case where a recommendation loss is calculated based on additional graph data is described with reference to FIGS. 5 and 6.

In FIG. 5, adjacent subject nodes or persona nodes are indicated by thick lines, the reference being the subject node C.

First, the recommendation loss calculation unit 105 calculates, for each of the subject nodes and each of the persona nodes, a first similarity in representations to a subject node or a persona node that belongs to the category B35 and is connected to a subject node or a persona node belonging to the category A30 by an edge 32.

As illustrated in FIG. 5, the first similarity regarding the subject node C is calculated from one of a similarity between the subject representations of the user C corresponding to the subject node C and the subject representations of the product a corresponding to the subject node a adjacent to the subject node C, the product b corresponding to the subject node b, the product c corresponding to the subject node c, or the product d corresponding to the subject node d, or the persona representations corresponding to a persona node d1.

In FIG. 6, subject nodes or persona nodes that are not adjacent are indicated by thick dashed lines, the reference being a persona node C2 that is a persona of the subject node C.

The recommendation loss calculation unit 105 calculates a second similarity in representations to a subject node or a persona node that belongs to the category B35 and is not connected to any persona node belonging to the category A30 by an edge 32. As illustrated in FIG. 6, the second similarity for the persona node C2 is calculated from one of the similarities between the persona representations of the persona C2 of the user C and the subject representations of the respective products a, b, and e corresponding to the subject nodes a, b, and e to which the persona C2 and an edge 32 are not connected or the persona representations of the persona d2 corresponding to the persona node d2.

For example, the recommendation loss calculation unit 105 calculates a difference between the first similarity and the second similarity obtained for the subject node C and the persona C2 calculated as illustrated in FIGS. 5 and 6, as a loss of the subject node C. The recommendation loss calculation unit 105 is only required to calculate an average value of the losses of all or some of the subject nodes as a recommendation loss.

Note that, in FIGS. 5 and 6, the recommendation loss according to Expression (1) is assumed, but some other combinations may be used. For example, assuming that the recommendation loss according to Expression (1) is a first calculation method, the recommendation loss calculation unit 105 calculates, as a second calculation method, a difference between the first similarity between a first subject node selected from the category A30 and a subject node or a persona node in the category B35 connected thereto by an edge 32, and the second similarity between the first subject node and a subject node in a node in the persona in the category B35 that is not connected by any edge 32, for each subject node. The recommendation loss may be calculated from an average value of differences calculated for the respective subject nodes. Specifically, taking FIG. 3 as an example, it is only required to calculate a difference between the first similarity between the subject node C and the subject nodes a, b, c, and d and the persona node d1 that are connected thereto by edges 32, and the second similarity between the subject node C and the subject node e and the persona node d2 that are not connected thereto by any edge.

Further, the recommendation loss calculation unit 105 calculates, as a third calculation method, a difference between the first similarity between a first persona node selected from the category A30 and a subject node or a persona node in the category B35 connected thereto by an edge 32, and the second similarity between the first persona node and a subject node or a persona node in the category B35 that is not connected by any edge 32. The recommendation loss may be calculated from an average value of differences calculated for the respective persona nodes. Specifically, taking FIG. 3 as an example, it is only required to calculate a difference between the first similarity obtained between the persona node C2 and the subject nodes c and d and the persona node d1 that are connected thereto by edges 32, and the second similarity between the persona node C2 and the subject nodes a, b, and e and the persona node d2 that are not connected thereto by any edge 32.

Further, as a fourth calculation method, the recommendation loss calculation unit 105 calculates a difference between the first similarity between a first persona node selected from the category A30 and a subject node or a persona node in the category B35 connected thereto by an edge 32, and the second similarity between the first subject node and a subject node or a persona node in the category B35 that is not connected by any edge 32. The recommendation loss calculation unit 105 may calculate the recommendation loss from an average value of differences calculated for the respective persona nodes. Specifically, taking FIG. 3 as an example, it is only required to calculate a difference between the first similarity obtained between the persona node C2 and the subject nodes c and d and the persona node d1 that are connected thereto by edges 32, and the second similarity obtained between the subject node C and the subject node e and the persona node d2 that are not connected thereto by any edge.

Further, the recommendation loss calculation unit 105 may calculate the recommendation loss, using a combination of at least two of the first to fourth calculation methods. For example, the recommendation loss calculation unit 105 may set a weighted sum of the respective calculation methods as the recommendation loss.

Note that, as a recommendation loss from a different point of view, the recommendation loss calculation unit 105 may calculate a difference between the first similarity between a first persona node selected from the category A30 and a subject node or a persona node in the category B35 that is not connected thereto by any edge 32, and the second similarity between the first subject node and a subject node or a persona node in the category B35 that is not connected thereto by any edge 32. The recommendation loss calculation unit 105 may calculate an additional recommendation loss (also called a third loss) from an average value of differences calculated for the respective first persona nodes.

The additional recommendation loss is a loss for considering what features are present in a product that neither a user nor a persona has purchased. The update unit 107 may update the parameters of the model, based on the recommendation loss, the additional recommendation loss, and the comparison loss.

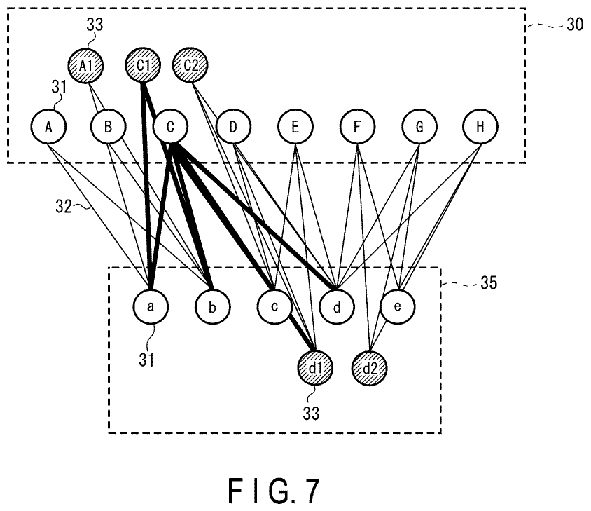

Next, a relationship between nodes in a case where a comparison loss is calculated based on additional graph data is described with reference to FIG. 7.

FIG. 7 is additional graph nodes similar to those in FIGS. 5 and 6, in which subject nodes or persona nodes adjacent to the subject node C and a persona node C1 are indicated by thick lines.

The comparison loss calculation unit 106 calculates a difference between the first similarity between a first subject node selected from the category A30 and a subject node or a persona node in the category B35 that is connected thereto by an edge 32, and the second similarity between a first persona node and a subject node or a persona node in the category B35 that is connected thereto by an edge 32.

Specifically, the comparison loss calculation unit 106 calculates a similarity between the persona node C1 and the subject nodes a and b connected thereto by edges 32 as the first similarity, and calculates a similarity between the subject node C and the subject nodes a, b, c, and d and the persona node d1 connected thereto by edges 32 as the second similarity. The comparison loss calculation unit 106 may calculate a difference between the first similarity and the second similarity, and calculate the comparison loss from an average value of differences calculated for the respective persona nodes.

According to the present embodiment described above, additional graph data in which a persona related to a subject node is added as a node is generated, a recommendation loss and a comparison loss are calculated from subject representations and persona representations, and the parameters of the model for extracting representations from graph data are updated based on the recommendation loss and the comparison loss. As a result, a relationship between subjects can be efficiently trained. For example, in training the model for the relative level of a purchase probability between a user and a product, which is a rank, training is performed so that the representations of the user and the representations of a persona are separated, and thus, the model can be trained to obtain a relative relationship indicating which one of the user and the persona is likely to purchase the product. Furthermore, as the representations are separated between the user and personas, it is possible to improve the interpretability of the model as to which persona is likely to purchase the product. That is, it is possible to provide a trained model with an improved interpretability.

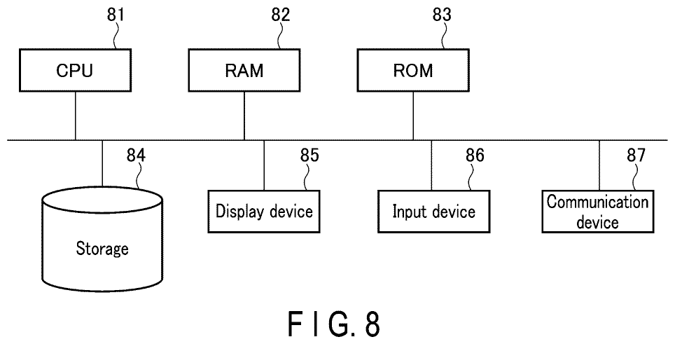

Here, an example of the hardware configuration of the information processing apparatus 10 according to the above embodiment is described with reference to a block diagram in FIG. 8.

The information processing apparatus 10 includes a central processing unit (CPU) 81, a random access memory (RAM) 82, a read only memory (ROM) 83, a storage 84, a display device 85, an input device 86, and a communication device 87, which are connected by a bus.

The CPU 81 is a processor that performs an arithmetic process, a control process, and the like in accordance with programs. The CPU 81 uses a predetermined area of the RAM 82 as a work area, and executes processing to be performed by each component of the information processing apparatus 10 described above and a server 11, in cooperation with programs stored in the ROM 83, the storage 84, and the like.

The RAM 82 is a memory such as a synchronous dynamic random access memory (SDRAM). The RAM 82 functions as a work area for the CPU 81. The ROM 83 is a memory that stores programs and various kinds of information in a non-rewritable manner.

The storage 84 is a device that writes and reads data into and from a magnetic recording medium such as a hard disc drive (HDD), a semiconductor storage medium such as a flash memory, an optically recordable storage medium, or the like. The storage 84 writes and reads data into and from a storage medium, under the control of the CPU 81.

The display device 85 is a display device such as a liquid crystal display (LCD). The display device 85 displays various kinds of information, based on a display signal from the CPU 81.

The input device 86 includes input devices such as a mouse and a keyboard. The input device 86 receives information that has been input by an operation from the user as an instruction signal, and outputs the instruction signal to the CPU 81.

The communication device 87 communicates with an external device via a network, under the control of the CPU 81.

The instructions shown in the processing procedures described in the above embodiment can be executed based on a program that is software. By storing this program in advance and reading this program, a general-purpose computer system can achieve effects similar to the effects of a control operation on the above-described learning system (a local device and a server). The instructions described in the above embodiment are recorded as a program that can be executed by a computer, into a magnetic disk (a flexible disk, a hard disk, or the like), an optical disk (a CD-ROM, a CD-R, a CD-RW, a DVD-ROM, a DVD±R, a DVD±RW, a Blu-ray (registered trademark) Disc, or the like), a semiconductor memory, or a recording medium similar to them. The storage format may be in any form, as long as the recording medium can be read by a computer or a system into which a computer is incorporated. In a case where a computer reads a program from the recording medium and causes the CPU to execute, based on the program, the instructions written in the program, it is possible to realize an operation similar to the control on the learning system (a local device and a server) of the above-described embodiment. In a case where the computer acquires or reads the program, the program may or course be acquired or read through a network.

Further, an operating system (OS), database management software, middleware (MW) such as a network, or the like that is running in a computer based on instructions in a program installed from a recording medium into the computer or a system into which the computer is incorporated may execute part of each process for realizing the present embodiment.

Furthermore, a recording medium in the present embodiment is not limited to a medium independent of the computer or the system into which the computer is incorporated, and includes a recording medium that downloads and stores or temporarily stores a program transmitted via a LAN, the Internet, or the like.

Furthermore, the number of recording media is not limited to one, and a case where processing according to the present embodiment is executed from a plurality of media is also included in the recording media in the present embodiment, and the configuration of the media may be any configuration.

Note that the computer or the system into which the computer is incorporated in the present embodiment is for executing each process in the present embodiment based on a program stored in a recording medium, and may have any configuration of a device formed with a single personal computer, a single microcomputer, or the like, a system in which a plurality of devices is connected to a network, or the like.

Further, the computer in the present embodiment is not limited to a personal computer, but includes an arithmetic processing device, a microcomputer, or the like included in an information processing apparatus, and collectively refers to machines and devices capable of realizing the functions in the present embodiment in accordance with a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor configured to:
acquire graph data in which a plurality of subjects is represented by nodes for each of two or more categories, and a relationship between the subjects is represented by an edge connecting the nodes;
generate additional graph data in which one or more personas having representative features of the subjects are added to the graph data as the nodes;
extract subject representations and persona representations from the additional graph data, using a model for extracting representations;
calculate a first loss depending on a difference between a similarity between nodes connected by the edge and a similarity between nodes not connected by the edge, using the subject representations and the persona representations;
calculate a second loss depending on a difference between a similarity between a node of the subject and a node connected to the node of the subject, and a similarity between a node of the persona and a node connected to the node of the persona, using the subject representations and the persona representations; and
update the model, using the first loss and the second loss.

2. The apparatus according to claim 1, wherein the processor is configured to update a parameter of the model so that the difference relating to the first loss and the difference relating to the second loss become larger.

3. The apparatus according to claim 1, wherein
the persona is generated for each of the subjects, and
the processor is configured to calculate the first loss, depending on a difference between a similarity between a node of a first subject among the subjects and a node of another subject or the persona connected by the edge, and a similarity between a node of a first persona among the personas and a node of the subject or another persona not connected by the edge.

4. The apparatus according to claim 1, wherein the processor is configured to calculate the first loss, depending on a difference between a similarity between a node of a first subject among the subjects and a node of another subject or the persona connected by the edge, and a similarity between a node of the first subject and a node of the another subject or the persona not connected by the edge.

5. The apparatus according to claim 1, wherein
the persona is generated for each of the subjects, and
the processor is configured to calculate the first loss, depending on a difference between a similarity between a node of a first persona among the personas and a node of the subject or another persona connected by the edge, and a similarity between a node of the first persona and a node of the subject or the another persona not connected by the edge.

6. The apparatus according to claim 1, wherein
the persona is generated for each of the subjects, and
the processor is configured to calculate the first loss, depending on a difference between a similarity between a node of a first persona among the personas and a node of the subject or another persona connected by the edge, and a similarity between a node of a first subject among the subjects and a node of another subject or the persona not connected by the edge.

7. The apparatus according to claim 1, wherein the processor is configured to calculate the first loss, depending on at least two combinations of differences between a similarity between the subjects or the personas connected by the edge, and a similarity between the subjects or the personas not connected by the edge.

8. The apparatus according to claim 1, wherein
the persona is generated for each of the subjects,
the processor is configured to calculate a third loss, depending on a difference between a similarity between a node of a first persona among the personas and a node of the subject or another persona not connected by the edge, and a similarity between a node of a first subject among the subjects and a node of another subject or the persona not connected by the edge; and
the update unit updates the model, using the first loss, the second loss, and the third loss.

9. The apparatus according to claim 1, wherein the graph data expresses a purchasing relationship between a person and a product, or a visiting relationship between a person and a place.

10. The apparatus according to claim 1, wherein the processor is configured to extract the subject representations and the persona representations, using a graph neural network having a message passing mechanism, including a graph convolution network, a GAT, a GraphSAGE, or a GIN.

11. The apparatus according to claim 1, wherein the processor is configured to generate the personas, using an egocentric network, a graph Laplacian, or a rich curvature.

12. An information processing method comprising:
acquiring graph data in which a plurality of subjects is represented by nodes for each of two or more categories, and a relationship between the subjects is represented by an edge connecting the nodes;
generating additional graph data in which one or more personas having representative features of the subjects are added to the graph data as the nodes;
extracting subject representations and persona representations from the additional graph data, using a model for extracting representations;
calculating a first loss depending on a difference between a similarity between nodes connected by the edge and a similarity between nodes not connected by the edge, using the subject representations and the persona representations;
calculating a second loss depending on a difference between a similarity between a node of the subject and a node connected to the node of the subject, and a similarity between a node of the persona and a node connected to the node of the persona, using the subject representations and the persona representations; and
updating the model, using the first loss and the second loss.

13. A non-transitory computer readable medium including computer executable instructions, wherein the instructions, when executed by a processor, cause the processor to perform a method comprising:
acquiring graph data in which a plurality of subjects is represented by nodes for each of two or more categories, and a relationship between the subjects is represented by an edge connecting the nodes;
generating additional graph data in which one or more personas having representative features of the subjects are added to the graph data as the nodes;
extracting subject representations and persona representations from the additional graph data, using a model for extracting representations;
calculating a first loss depending on a difference between a similarity between nodes connected by the edge and a similarity between nodes not connected by the edge, using the subject representations and the persona representations;
calculating a second loss depending on a difference between a similarity between a node of the subject and a node connected to the node of the subject, and a similarity between a node of the persona and a node connected to the node of the persona, using the subject representations and the persona representations; and
updating the model, using the first loss and the second loss.
